(19) United States
(12) Patent Application Publication
(10) Pub. No.: US 2015/0135116 A1
(43) Pub. Date: May 14, 2015

(54) CONTROL USER INTERFACE ELEMENT FOR CONTINUOUS VARIABLE

(71) Applicant: Microsoft Corporation, Redmond, WA (US)

(72) Inventors: Luis E. Cabrera-Cordon, Bothell, WA (US); Romualdo T. Impas, Seattle, WA (US); David Buerer, Woodinville, WA (US); Norberto Arrieta, Redmond, WA (US); Daniel Dole, Seattle, WA (US)

(73) Assignee: Microsoft Corporation, Redmond, WA (US)

(21) Appl. No.: 14/080,091

(22) Filed: Nov. 14, 2013

(51) Int. Cl. G06F 3/0484

(52) U.S. Cl. CPC G06F 3/0484
USPC 715/771

(57) ABSTRACT

One or more techniques and/or systems are provided for providing a control user interface (UI) element. The control UI element, associated with a continuous variable, may be displayed, such as in association with a user interface (e.g., the control UI element may correspond to a view rotation variable of a map interface). The control UI element may comprise a current state indicator element configured to display a current state of the continuous variable (e.g., a compass displaying a current heading associated with the view rotation variable). The control UI element may be populated with one or more expanded control elements associated with various aspects of the continuous variable (e.g., a first expanded control element may be used to modify a right rotation aspect of the view rotation variable and a second expanded control element may be used to modify a left rotation aspect of the view rotation variable).

### BACKGROUND

Many user interfaces may be associated with continuous variables. In an example, a map interface may be associated with a view tilt variable, a view rotation variable, and/or other continuous variables. In another example, a thermostat interface may be associated with a temperature variable. In another example, a videogame driving interface may be associated with a speed variable and/or a steering variable. Such interfaces may allow users to modify continuous variables through user input. In an example, the thermostat interface may allow a user to input a particular temperature and/or may provide a temperature increase button and temperature decrease button. In another example, the videogame driving interface may accept input from a videogame controller comprising an acceleration button, a deceleration button, and/or a steering input pad.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for providing a control user interface (UI) element are provided herein. Various interfaces may be associated with continuous variables (e.g., manufacturing equipment that provides control for temperatures, extrusion rates, mixing rates, flow rates, etc; a videogame with movement and/or speed controls; a map with tilt and/or rotational view navigation; etc.). Accordingly, a control UI element associated with a continuous variable may be displayed. The control UI element may be populated with a current state indicator element configured to display a current state of the continuous variable (e.g., a compass displaying a current heading of a map; a numerical indicator displaying a current temperature; a color corresponding to a color value being assigned to an object within a paint user interface).

The control UI element may allow a user to control various aspects of the continuous variable and/or other continuous variables using a variety of input commands (e.g., touch input, mouse/keyboard input, voice input, motion sensing input, etc.). In an example, the control UI element may be populated with one or more expanded control elements based upon receiving a show capabilities input associated with the current state indicator element (e.g., a press down touch input on the current state indicator element; a voice command “show capabilities”; etc.). A first expanded control element may be associated with a first aspect of the continuous variable (e.g., increase temperature), a second expanded control element may be associated with a second aspect of the continuous variable (e.g., decrease temperature), and/or other expanded control elements may be associated with other aspects of the continuous variable and/or other continuous variables (e.g., a third expanded control element and a fourth expanded control element may be associated with a fan speed for a heater). An expanded control element may be configured to accept analog input (e.g., the further the current state indicator element is moved from an initial position along the first expanded control element, the faster the temperature is increased) and/or discrete input (e.g., the temperature may be increased by a degree responsive to a click input of the first expanded control element). In this way, various aspects of continuous variables may be controlled through the control UI element.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of providing a control user interface (UI) element.

FIG. 2A is a component block diagram illustrating an exemplary system for providing a control UI element.

FIG. 2B is a component block diagram illustrating an exemplary system for providing a control UI element.

FIG. 2C is a component block diagram illustrating an exemplary system for modifying a first aspect of a continuous variable based upon input associated with a control UI element.

FIG. 2D is a component block diagram illustrating an exemplary system for modifying a first aspect of a continuous variable based upon input associated with a control UI element.

FIG. 2E is a component block diagram illustrating an exemplary system for modifying a first aspect of a continuous variable based upon input associated with a control UI element.

FIG. 2F is a component block diagram illustrating an exemplary system for providing a control UI element.

FIG. 2G is a component block diagram illustrating an exemplary system for modifying a second aspect of a continuous variable based upon input associated with a control UI element.

FIG. 3A is an illustration of an example of a control UI element populated with a first expanded control element and/or a second expanded control element.

FIG. 3B is an illustration of an example of a control UI element populated with a first expanded control element and/or a second expanded control element.

FIG. 3C is an illustration of an example of a control UI element populated with a first expanded control element, a second expanded control element, a third expanded control element, and/or a fourth expanded control element.

FIG. 3D is an illustration of an example of a control UI element populated with a radial expanded control element.

FIG. 4A is an illustration of an example of a control UI element.

FIG. 4B is an illustration of an example of a control UI element.

FIG. 4C is an illustration of an example of a control UI element.

FIG. 4D is an illustration of an example of a control UI element.

FIG. 4E is an illustration of an example of a control UI element.

FIG. 5 is an illustration of an exemplary computer readable medium wherein processor-executable instructions configured to embody one or more of the provisions set forth herein may be comprised.

FIG. 6 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

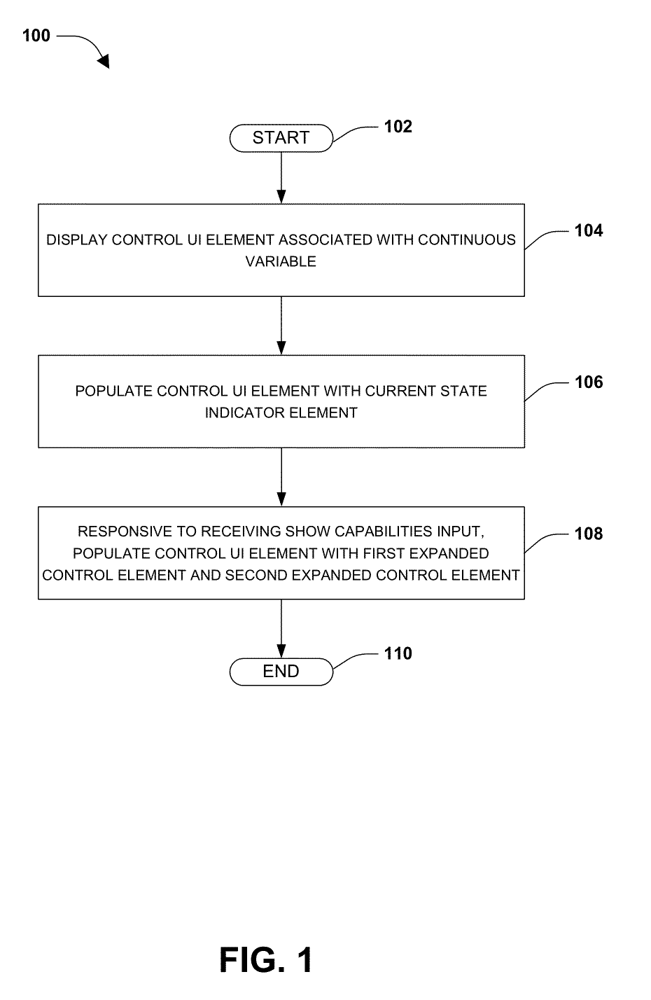

An embodiment of providing a control user interface (UI) element is illustrated by an exemplary method 100 of FIG. 1. At 102, the method starts. At 104, a control UI element associated with a continuous variable may be displayed, such as in association with a user interface (e.g., a map user interface; a manufacturing plant control user interface; a handicap driving assistance user interface; a mobile device app; a videogame; a television or cable interface; a graphics design interface; and/or a wide variety of other user interfaces that may be associated with continuous variables). For example, the control UI element may be displayed in association with a map user interface. The control UI element may be associated with a view tilt variable for a map displayed through the map user interface. In an example, the control UI element may be displayed over the map user interface. Various aspects of the control UI element, such as color and/or transparency, may be dynamically adjusted based upon the user interface, such as whether the map user interface comprises a symbolic map or a 3D photorealistic map, in order to improve visibility of the user interface. In another example, the control UI element may be displayed through a second interface, such as a sidebar interface adjacent to the user interface or through a windowed/floating interface.

At 106, the control UI element may be populated with a current state indicator element configured to display a current state of the continuous variable. For example, the current state indicator element may display a numerical value or other indicator corresponding to a current tilt view angle for the map user interface. At 108, responsive to receiving a show capabilities input associated with the current state indicator element (e.g., a press down touch input; a mouse click and hold input; a hover input; etc.), the control UI element may be populated with one or more expanded control elements along which the current state indicator element may be moved to adjust various aspects of the continuous variable. In an example, a first expanded control element may be associated with a first aspect of the continuous variable (e.g., a right tilt aspect of the view tilt variable). In an example, a second expanded control element may be associated with a second aspect of the continuous variable (e.g., a left tilt aspect of the view tilt variable). In another example, a third expanded control element associated with a third aspect of the continuous variable, a fourth expanded control element associated with a fourth aspect of the continuous variable, and/or other expanded control elements may be populated within the control UI element. In an example, the one or more expanded control elements may be populated as a radial expanded control element.

The control UI element may allow a user to control various aspects of the continuous variable based upon analog input (e.g., dragging the current state indicator element along an expanded control element) and/or discrete input (e.g., clicking an expanded control element). In an example, responsive to receiving first analog input, through the current state indicator element, with respect to the first expanded control element (e.g., the user may drag the current state indicator element from an initial position to a first position along the first expanded control element), the first aspect of the continuous variable may be modified according to the first analog input (e.g., the view of a map displayed by the map user interface may be tilted to the right at a rate corresponding to a distance the current state indicator was dragged along the first expanded control element). In an example, the current state indicator element may be modified to visually reflect the modified first aspect (e.g., a numerical tilt view angle value may be displayed and/or updated). Responsive to receiving second analog input, through the current state indicator element, with respect to the second expanded control element (e.g., the user may drag the current state indicator to a second position along the second expanded control element), the second aspect of the continuous variable may be modified according to the second analog input (e.g., the view of the map may be tilted to the left at a rate corresponding to a distance the current state indicator was dragged along the second expanded control element). In an example, the current state indicator element may be modified to visually reflect the modified second aspect (e.g., a numerical tilt view angle value may be displayed and/or updated). Analog input through the current state indicator element may control a tilt velocity, such as a rate at which the view of the map is tilted (e.g., the tilt velocity may be increased by moving the current state indicator element further along the first expanded control element and/or further along the second expanded control element, such as a direction away from the initial position of the current state indicator element; the tilt velocity may be decreased, such as for finer grain control, by moving the current state indicator element closer to the initial position of the current state indicator element; etc.).

In an example, responsive to receiving a first discrete input, through the control UI element, with respect to the first expanded control element (e.g., the user may click the first expanded control element; a voice command or motion command mapped to the first expanded control element may be detected; etc.), the first aspect of the continuous variable may be modified according to the first discrete input (e.g., the tilt angle may be changed by 1 degree to the right). In an example, the current state indicator element may be modified to visually reflect the modified first aspect (e.g., a numerical tilt view angle value may be displayed and/or updated). Responsive to receiving a second discrete input, through the control UI element, with respect to the second expanded control element (e.g., the user may click the second expanded control element; a voice command or motion command mapped to the second expanded control element may be detected; etc.), the second aspect of the continuous variable may be modified according to the second discrete input (e.g., the tilt angle may be changed by 1 degree to the left). In an example, the current state indicator element may be modified to visually reflect the modified second aspect (e.g., a numerical tilt view angle value may be displayed and/or updated). In this way, various types of input may be facilitated through the control UI element, such as analog input, discrete input, and/or other input commands such as a neutral input associated with the current state indicator element (e.g., a single click or tap on the current state indicator element) that invokes modification of the continuous variable (e.g., the map may be modified from a tiled view to a nadir view; with respect to a continuous view rotation variable, a heading of the map may be oriented to north; etc.).

The visual appearance of the control UI element may be modified based on the visibility, state and/or style, etc. of an underlying user interface, such as a map interface (e.g., to reduce, modify, control, etc. a degree of occlusion of the underlying user interface by the control UI element). For example, the control UI element and/or elements therein may be assigned a first color and/or a first transparency based upon the map interface displaying a photorealistic map, and may be assigned a second color and/or a second transparency based upon the map interface displaying a symbolic map. In an example, the control UI element may be collapsed (e.g., reduced in size; the first expanded control element and/or the second expanded control element may be faded from view and/or collapsed towards the current state indicator element; etc.) responsive to identifying an interaction timeout (e.g., 2 seconds without user input) associated with the current state indicator element. At 110, the method ends.

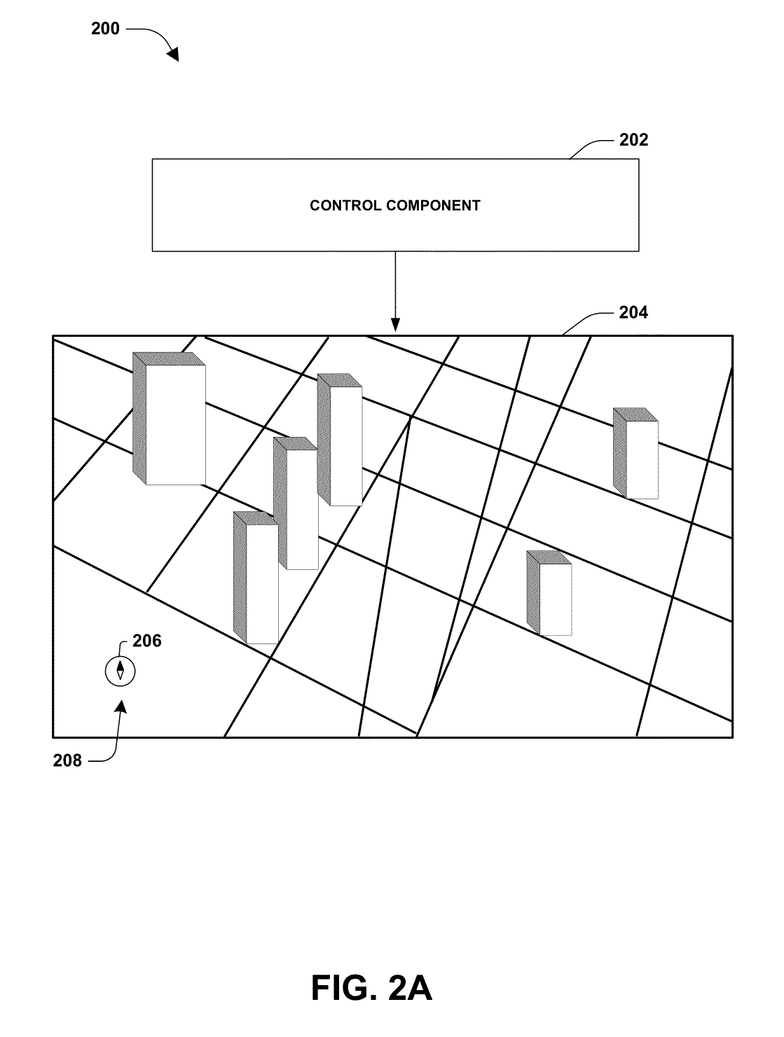

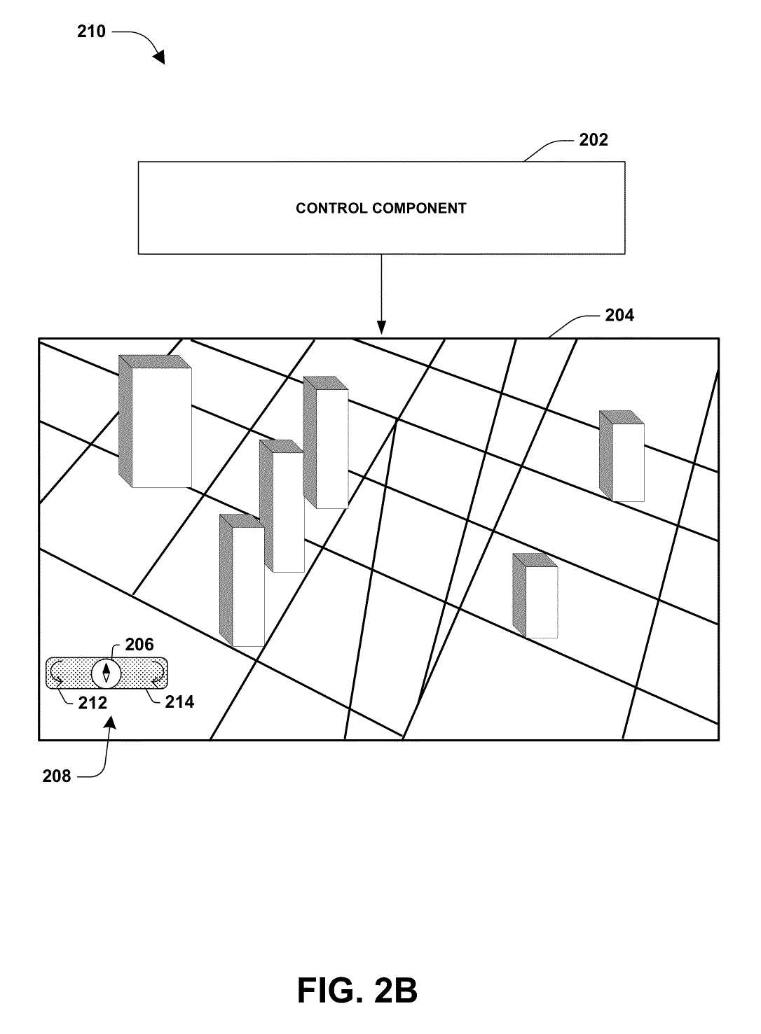

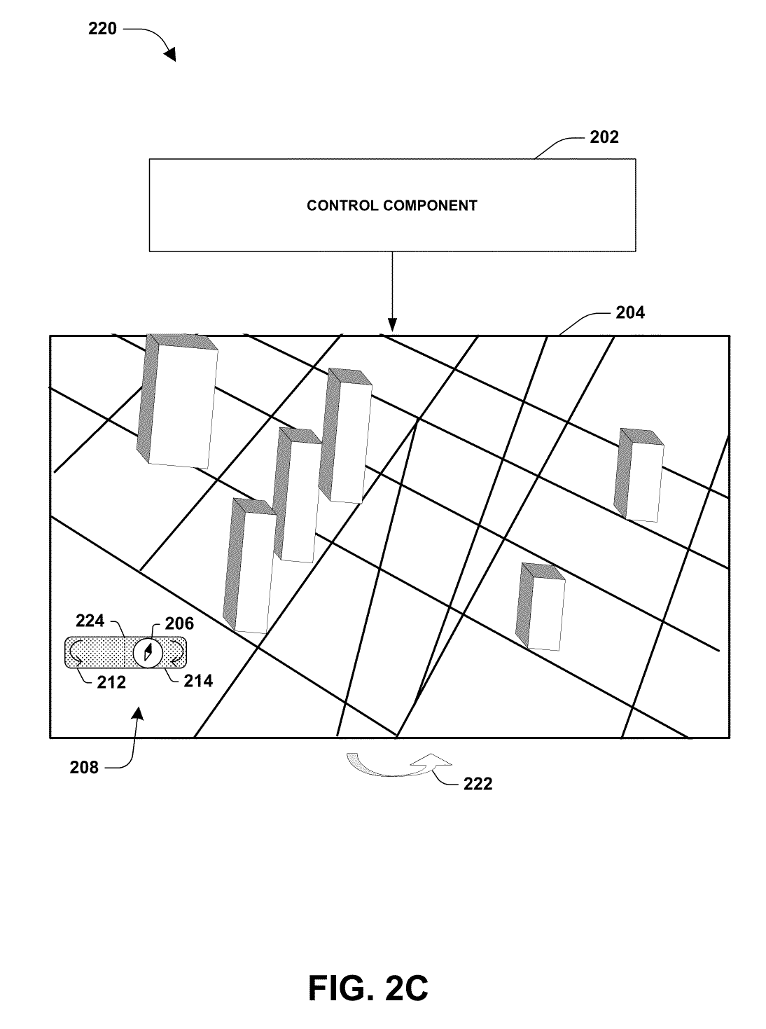

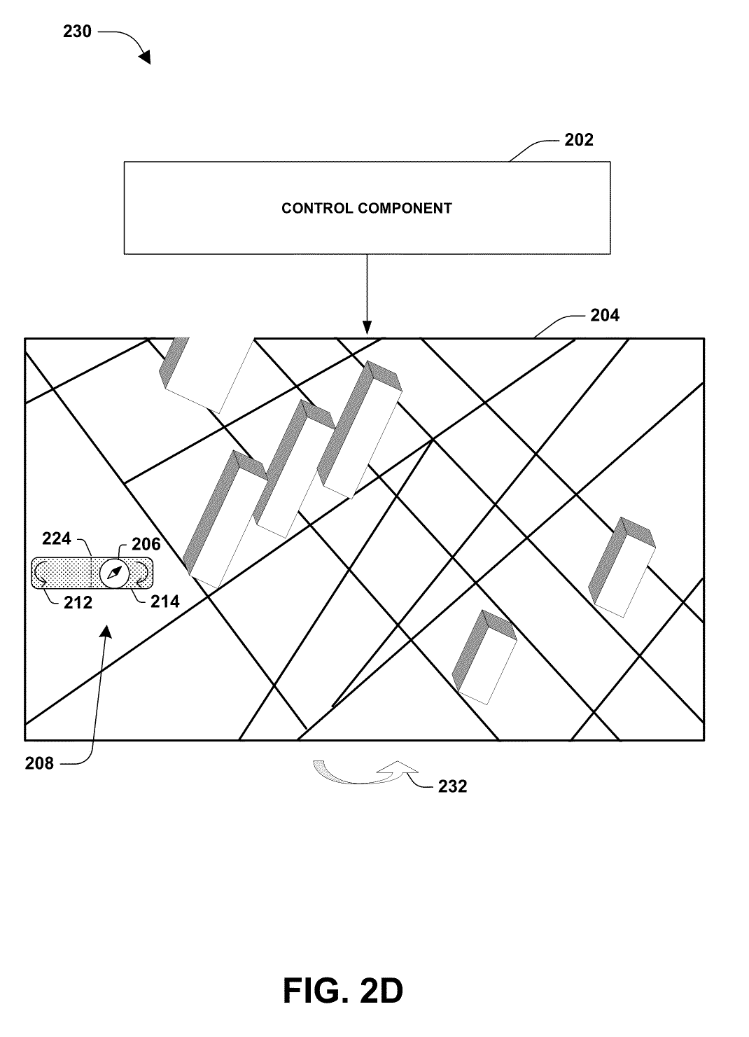

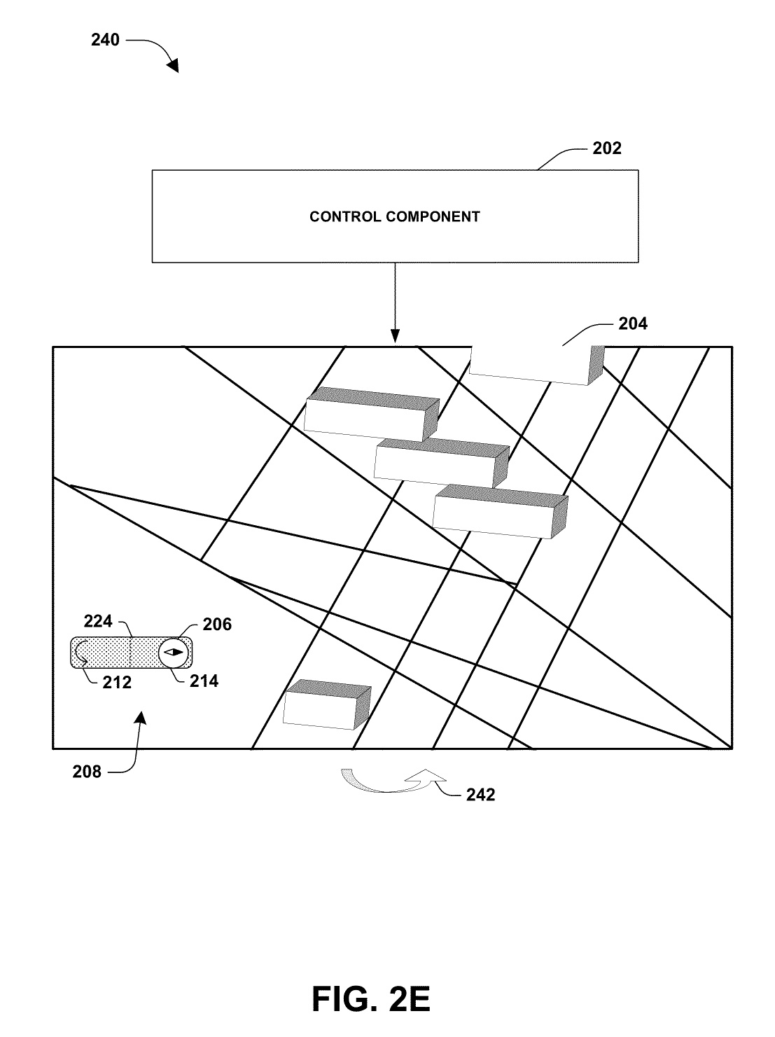

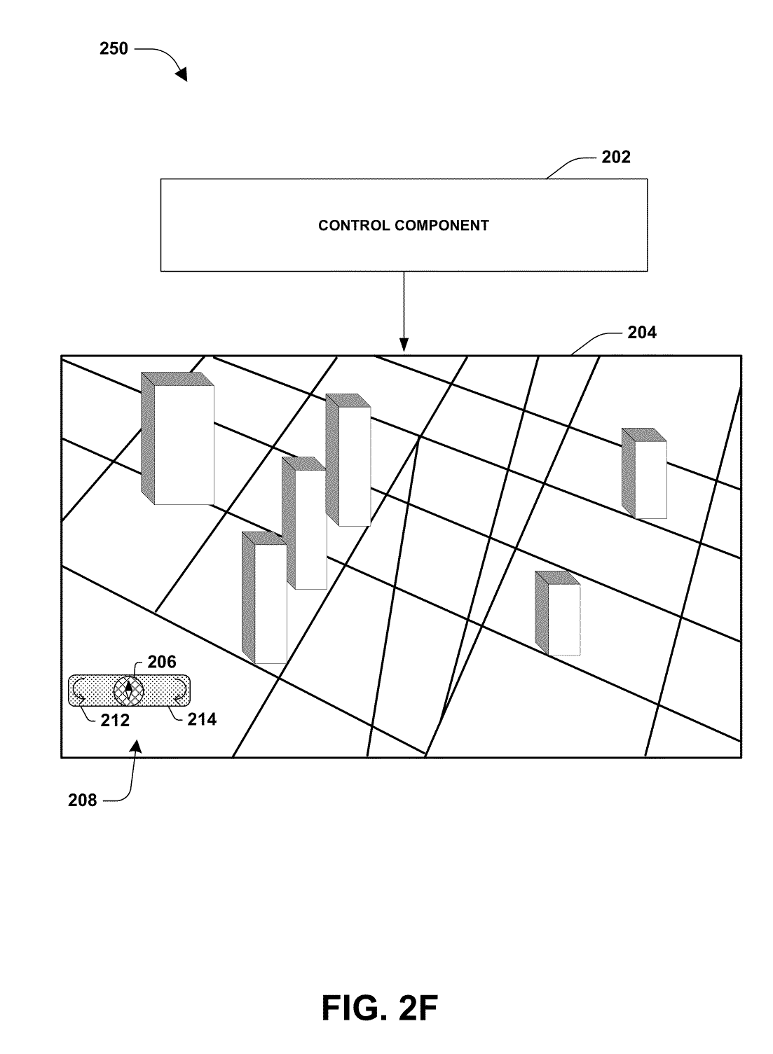

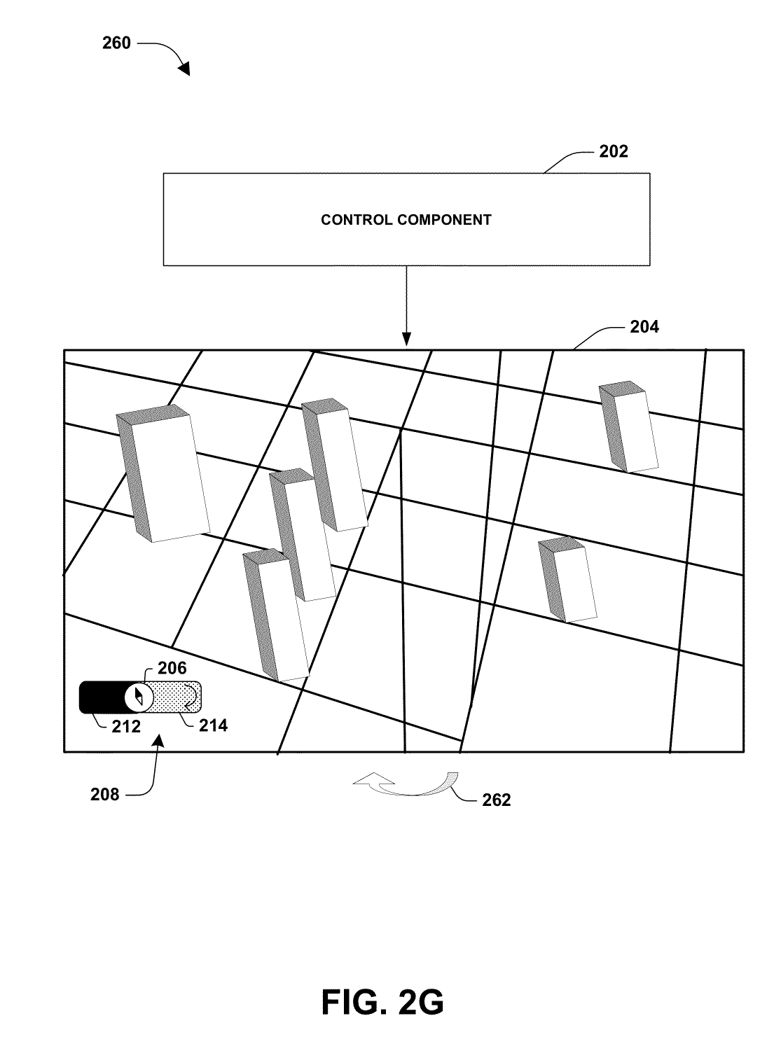

FIG. 2A illustrates an example of a system 200 for providing a control user interface (UI) element 208. The system 200 may comprise a control component 202. The control component 202 may be associated with a user interface, such as a map user interface 204 displaying a map. The control component 202 may display a control UI element 208. For example, the control component 202 may display the control UI element 208 overlaid the map user interface 204. The control component 202 may associate the control UI element 208 with a continuous variable of the map user interface 204, such as a view rotation variable. The control component 202 may be configured to populate the control UI element 208 with a current state indicator element 206. The current state indicator element 206 may be configured to display a current state of the continuous variable. For example, the current state indicator element 206 may display a compass corresponding to a current heading for the view rotation variable.

FIG. 2B illustrates an example of a system 210 for providing a control user interface (UI) element 208. The system may comprise a control component 202. In an example, the control component 202 may have displayed the control UI element 208, populated with a current state indicator element 206 associated with a continuous variable such as a view rotation variable, for a map user interface 204 (e.g., FIG. 2A). The control component 202 may detect a show capabilities input associated with the current state indicator element 206 (e.g., a user may touch or click the current state indicator element 206). Responsive to receiving the show capabilities input, the control component 202 may populate the control UI element 208 with one or more expanded control elements associated with the view rotation variable. For example, the control component 202 may populate the control UI element 208 with a first expanded control element 214 associated with a first aspect of the view rotation variable, such as a rotate right aspect. The control component 202 may populate the control UI element 208 with a second expanded control element 212 associated with a second aspect of the view rotation variable, such as a rotate left aspect. The one or more expanded control elements may be invoked to modify corresponding aspects of the view rotation variable (e.g., FIGS. 2C-2G).

FIG. 2C illustrates an example of a system 220 for modifying a first aspect of a continuous variable based upon input associated with a control UI element 208. The system may comprise a control component 202. In an example, the control component 202 may have displayed the control UI element 208 for a map user interface 204, where the control UI element 208 is populated with a current state indicator element 206 associated with a view rotation variable (e.g., FIG. 2A) and is populated with a first expanded control element 214 and a second expanded control element 212 (e.g., FIG. 2B). The control component 202 may detect input, such as analog input, associated with the first expanded control element 214. For example, a user may drag the current state indicator element 206 from an initial position 224 to a current position along the first expanded control element 214. Responsive to receiving the input, the control component 202 may modify a rotate right aspect of the view rotation variable associated with the first expanded control element 214. For example, the control component 202 may modify the view rotation variable in order to rotate 222 a map displayed by the map user interface 204. The control component 202 may modify the view rotation variable at a rate corresponding to the current position of the current state indicator element 206 along the first expanded control element 214 (e.g., a view rotation velocity may increase the further away the current state indicator element 206 is displaced from the initial position 224). The current state indicator element 206 may be updated to display a current state of the view rotation variable (e.g., a compass may display a current heading associated with the view rotation variable for the map). In this way, analog input for the view rotation variable may be facilitated.

FIG. 2D illustrates an example of a system 230 for modifying a first aspect of a continuous variable based upon input associated with a control UI element 208. The system may comprise a control component 202. In an example, the control component 202 may have displayed the control UI element 208 for a map user interface 204, where the control UI element 208 is populated with a current state indicator element 206 associated with a view rotation variable and is populated with a first expanded control element 214 and a second expanded control element 212 (e.g., FIG. 2B). In an example, the control component 202 may have modified the view rotation variable and rotated 222 a map displayed by the map user interface 204 based upon input corresponding to a user dragging the current state indicator element 206 from an initial position 224 to a current position along the first expanded control element 214 (e.g., FIG. 2C).

In an example, the user may maintain the current state indicator element 206 at the current position along the first expanded control element 214. Accordingly, the control component 202 may continue to modify the view rotation variable and rotate 232 the map at a view rotation velocity corresponding to the current position along the first expanded control element 214. The current state indicator element 206 may be updated to display a current state of the view rotation variable (e.g., a compass may rotate to display a current heading associated with the view rotation variable for the map). In this way, analog input for the view rotation variable may be facilitated.

FIG. 2E illustrates an example of a system 240 for modifying a first aspect of a continuous variable based upon input associated with a control UI element 208. The system may comprise a control component 202. In an example, the control component 202 may have displayed the control UI element 208 for a map user interface 204, where the control UI element 208 is populated with a current state indicator element 206 associated with a view rotation variable and is populated with a first expanded control element 214 and a second expanded control element 212 (e.g., FIG. 2B). In an example, the control component 202 may have modified the view rotation variable and rotated 222 a map displayed by the map user interface 204 based upon input corresponding to a user dragging the current state indicator element 206 from an initial position 224 to a current position along the first expanded control element 214 (e.g., FIG. 2C). In an example, the control component 202 may have continued to modify the view rotation variable and rotate 232 the map (e.g., at a view rotation velocity corresponding to the current position) based upon the user maintaining the current state indicator element 206 at the current position along the first expanded control element 214 (e.g., FIG. 2D).

In an example, the user may drag the current state indicator element 206 from the current position to a new position along the first expanded control element 214. The new position may correspond to a greater view rotation velocity (e.g., the new position illustrated in FIG. 2E is further from the initial position 224 than the current position illustrated in FIG. 2D). Accordingly, the control component 202 may modify the view rotation variable and rotate 242 the map at an increased view rotation velocity corresponding to the new position along the first expanded control element 214 (e.g., velocity of rotation in FIG. 2E is greater than velocity of rotation in FIG. 2D). The current state indicator element 206 may be updated to display a current state of the view rotation variable (e.g., a compass may display a current heading associated with the view rotation variable for the map). In this way, analog input for the view rotation variable may be facilitated.

FIG. 2F illustrates an example of a system 250 for providing a control user interface (UI) element 208. The system may comprise a control component 202. In an example, the control component 202 may have displayed the control UI element 208 for a map user interface 204, where the control UI element 208 is populated with a current state indicator element 206 associated with a view rotation variable and is populated with a first expanded control element 214 and a second expanded control element 212 (e.g., FIG. 2B). In an example, the control component 202 may have modified a view rotation variable and may have rotated a map displayed by the map user interface 204 based upon input associated with the first expanded control element 214 and/or other expanded control elements, resulting in the map having a rotated view (e.g., FIG. 2C-2E). The control component 202 may be configured to detect a neutral input associated with the current state indicator element 206 (e.g., a single click or a single tap input on the current state indicator element 206). Accordingly, the control component 202 may modify the view rotation variable based upon the neutral input. For example, the control component 202 may orient the map according to a North heading (e.g., an original heading, a default heading, etc.). The current state indicator element 206 may be updated to display a current state of the view rotation variable (e.g., a compass may point towards the North heading with respect to the map).

FIG. 2G illustrates an example of a system 260 for modifying a second aspect of a continuous variable based upon input associated with a control user interface (UI) element 208. The system may comprise a control component 202. In an example, the control component 202 may have displayed the control UI element 208 for a map user interface 204, where the control UI element 208 is populated with a current state indicator element 206 associated with a view rotation variable and is populated with a first expanded control element 214 and a second expanded control element 212 (e.g., FIG. 2B). The control component 202 may detect input, such as digital input, associated with the second expanded control element 212. For example, a user may touch or click the second expanded control element 212 (e.g., responsive to the input, the second expanded control element 212 may be visually modified, such as a color and/or transparency change). Responsive to receiving the input, the control component 202 may modify a rotate left aspect of the view rotation variable associated with the second expanded control element 212. For example, the control component 202 may modify the view rotation variable in order to rotate 262 a map displayed by the map user interface 204. The current state indicator element 206 may be updated to display a current state of the view rotation variable (e.g., a compass may display a current heading associated with the view rotation variable for the map). In this way, digital input for the view rotation variable may be facilitated.

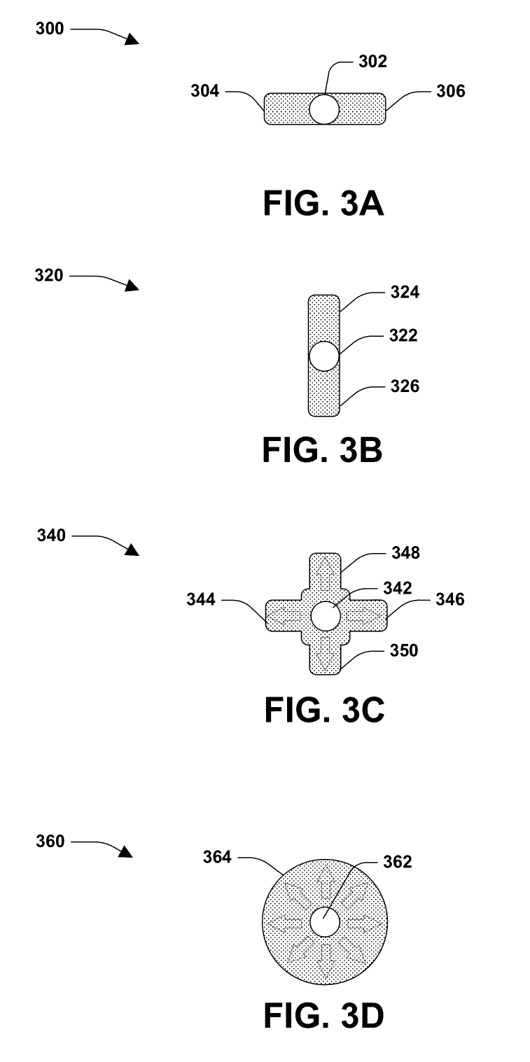

FIGS. 3A-3D illustrate examples of a control UI element. FIG. 3A illustrates an example of a control UI element 300 comprising a current state indicator 302 configured to display a current state of a continuous variable. The control UI element 300 may be populated with a first expanded control element 306 associated with a first aspect of the continuous variable. The control UI element 300 may be populated with a second expanded control element 304 associated with a second aspect of the continuous variable. FIG. 3B illustrates an example of a control UI element 320 comprising a current state indicator 322 configured to display a current state of a continuous variable. The control UI element 320 may be populated with a first expanded control element 326 associated with a first aspect of the continuous variable. The control UI element 320 may be populated with a second expanded control element 324 associated with a second aspect of the continuous variable.

FIG. 3C illustrates an example of a control UI element 340 comprising a current state indicator 342 configured to display a current state of a continuous variable. In an example, the control UI element 340 may be populated with a first expanded control element 346 associated with a first aspect of the continuous variable. The control UI element 340 may be populated with a second expanded control element 344 associated with a second aspect of the continuous variable. The control UI element 340 may be populated with a third expanded control element 348 associated with a third aspect of the continuous variable. The control UI element 340 may be populated with a fourth expanded control element 350 associated with a fourth aspect of the continuous variable. In another example, one or more of the expanded control elements may be associated with the continuous variable (e.g., the first expanded control element 346 may be associated with a right view rotation aspect of a view rotation variable and the second expanded control element 344 may be associated with a left rotation aspect of the view rotation variable), and one or more other expanded control elements may be associated with a second continuous variable (e.g., the third expanded control element 348 may be associated with an up view tilt aspect of a view tilt variable and the fourth expanded control element 350 may be associated with a down view tilt aspect of the view tilt variable). In this way, horizontal position change along the first expanded control element 346 and/or the second expanded control element 344 may correspond to a first variable (e.g., the view rotation variable), and vertical position change along the third expanded control element 348 and/or the fourth expanded control element 350 may correspond to a second variable (e.g., the view tilt variable). FIG. 3D illustrates an example of a control UI element 360 comprising a current state indicator 362 configured to display a current state of a continuous variable. One or more expanded control elements may be populated within a radial expanded control 364 (e.g., input may be received through the radial expanded control 364 similar to a joystick) to control one or more aspects of one or more continuous variables.

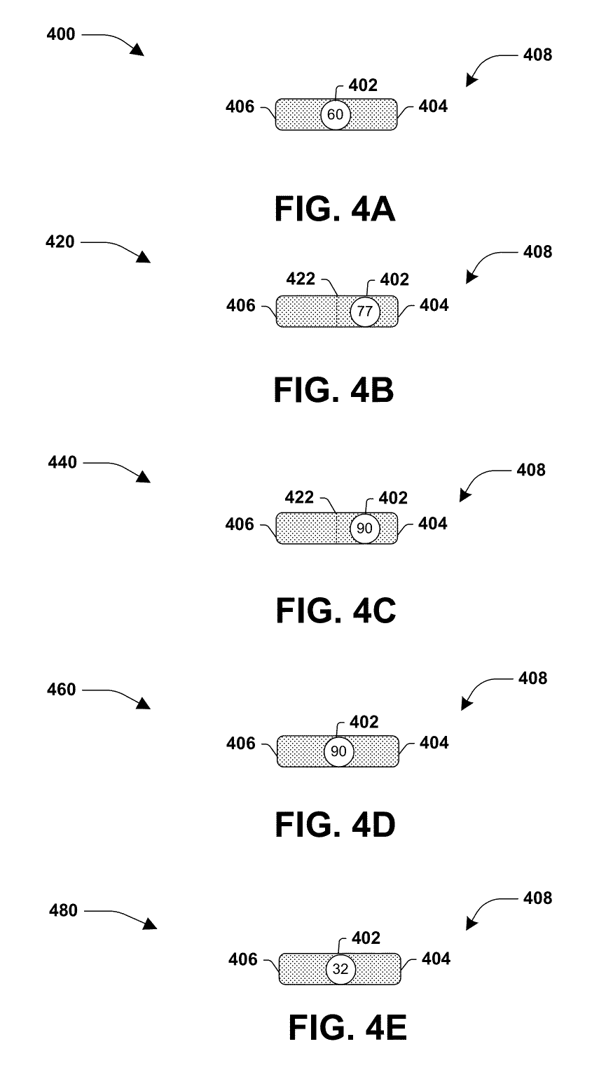

FIGS. 4A-4E illustrate examples of a control UI element 408 associated with a continuous temperature variable. FIG. 4A illustrates an example 400 of the control UI element 408 comprising a current state indicator element 402 configured to display a current state of the continuous temperature variable, such as 60° F. The control UI element 408 is populated with a first expanded control element 404 associated with a temperature increase aspect of the continuous temperature variable. The control UI element 408 is populated with a second expanded control element 406 associated with a temperature decrease aspect of the continuous temperature variable. FIG. 4B illustrates an example 420 of increasing the continuous temperature variable based upon analog input where a user drags the current state indicator element 402 from an initial position 422 to a current position along the first expanded control element 404. The current state indicator element 402 is updated to display a current temperature of 77° F. based upon the increase in the continuous temperature variable. FIG. 4C illustrates an example 440 of increasing the continuous temperature variable based upon the user maintaining the current state indicator element 402 at the current position along the first expanded control element 404 (e.g., the continuous temperature variable may continue to increase according to an increase rate corresponding to the current position). In an example, the rate at which the continuous temperature variable increases is a function of a distance of the current state indicator element 402 from the initial position 422 (e.g., the farther the current state indicator element 402 is from the initial position 422 the greater the rate at which the continuous temperature variable is increased (e.g., or is decreased as the current state indicator element 402 is moved to the second expanded control element 406)) The current state indicator element 402 is updated to display a current temperature of 90° F. based upon the increase in the continuous temperature variable. FIG. 4D illustrates an example 460 of maintaining a current value for the continuous temperature variable based upon the current state indicator element 402 being returned to the initial position 422. FIG. 4E illustrates an example 480 of switching the current state indicator element 402 from displaying temperature in Fahrenheit to Celsius based upon neutral input (e.g., a single click or tap on the current state indicator element 402).

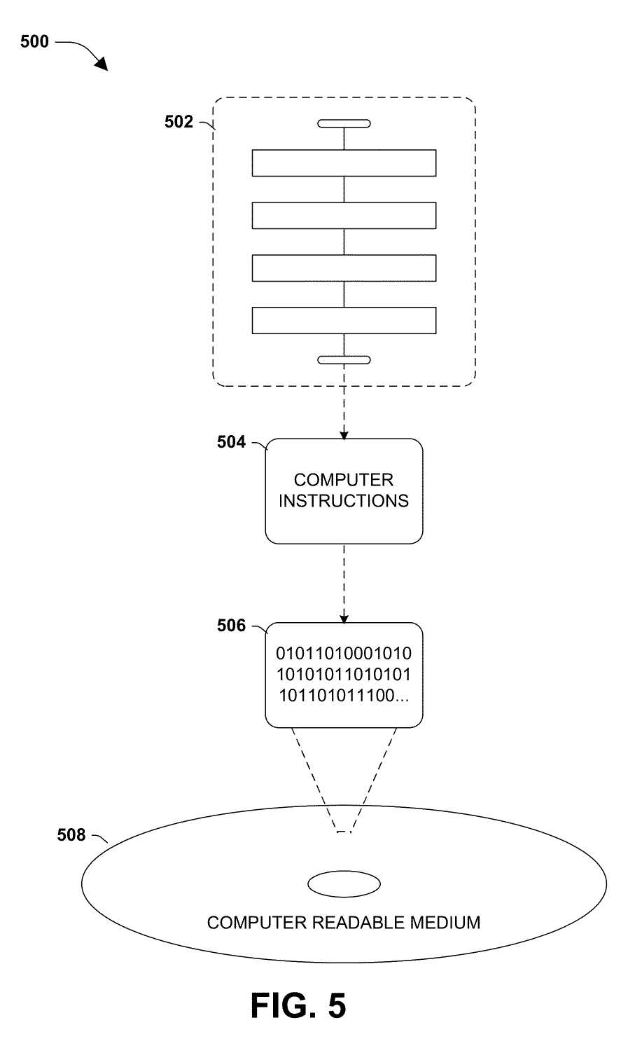

Still another embodiment involves a computer-readable medium comprising processor-executable instructions configured to implement one or more of the techniques presented herein. An example embodiment of a computer-readable medium or a computer-readable device is illustrated in FIG. 5, wherein the implementation 500 comprises a computer-readable medium 508, such as a CD-R, DVD-R, flash drive, a platter of a hard disk drive, etc., on which is encoded computer-readable data 506. This computer-readable data 506, such as binary data comprising at least one of a zero or a one, in turn comprises a set of computer instructions 504 configured to operate according to one or more of the principles set forth herein. In some embodiments, the processor-executable computer instructions 504 are configured to perform a method 502, such as at least some of the exemplary method 100 of FIG. 1, for example. In some embodiments, the processor-executable instructions 504 are configured to implement a system, such as at least some of the exemplary system 200 of FIG. 2A, at least some of the exemplary system 210 of FIG. 2B, at least some of the exemplary system 220 of FIG. 2C, at least some of the exemplary system 230 of FIG. 2D, at least some of the exemplary system 240 of FIG. 2E, at least some of the exemplary system 250 of FIG. 2F, and/or at least some of the exemplary system 260 of FIG. 2G, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

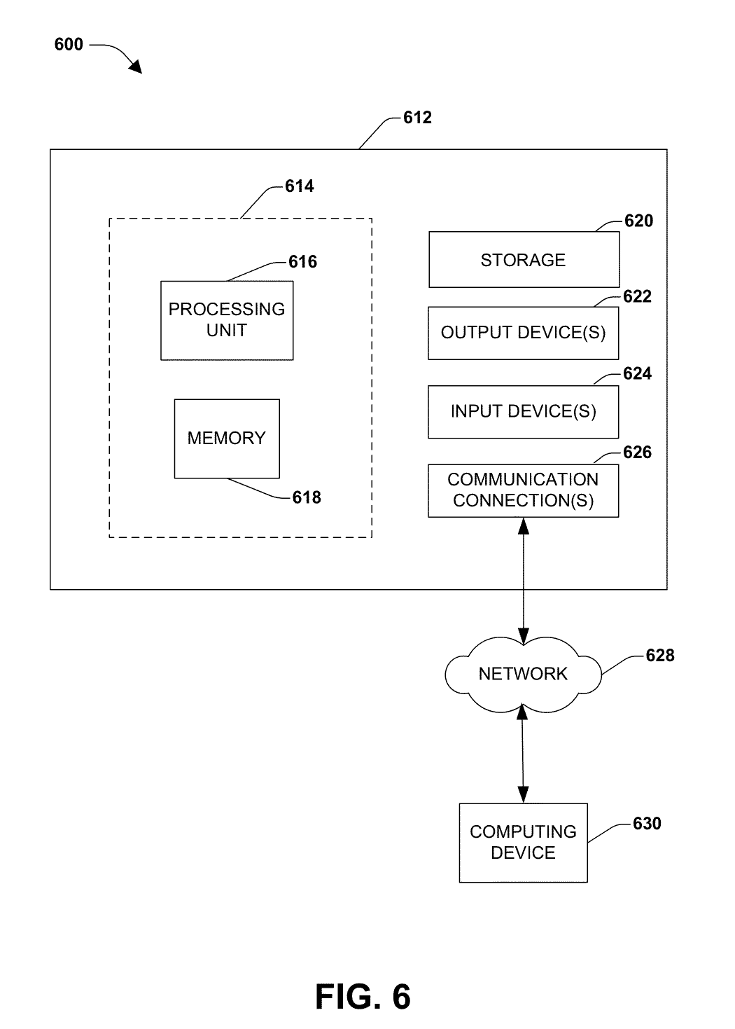

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 600 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, or any combination thereof. In one embodiment, an input device or an output device from another computing device may be used as input device(s) 624 or output device(s) 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via a network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for providing a control user interface (UI) element, comprising:
displaying a control UI element associated with a continuous variable;
populating the control UI element with a current state indictor element configured to display a current state of the continuous variable; and
responsive to receiving a show capabilities input associated with the current state indicator element, populating the control UI element with a first expanded control element associated with a first aspect of the continuous variable and a second expanded control element associated with a second aspect of the continuous variable.

2. The method of claim 1, comprising at least one of:
responsive to receiving first analog input, through the current state indicator element, with respect to the first expanded control element, modifying the first aspect according to the first analog input; or
responsive to receiving second analog input, through the current state indicator element, with respect to the second expanded control element, modifying the second aspect according to the second analog input.

3. The method of claim 1, comprising at least one of:
responsive to receiving first discrete input, through the control UI element, with respect to the first expanded control element, modifying the first aspect according to the first discrete input; or
responsive to receiving second discrete input, through the control UI element, with respect to the second expanded control element, modifying the second aspect according to the second discrete input.

4. The method of claim 1, the populating the control UI element comprising:
populating the control UI element with a third expanded control element associated with a third aspect of the continuous variable.

5. The method of claim 4, the populating the control UI element comprising:
populating the control UI element with a fourth expanded control element associated with a fourth aspect of the continuous variable.

6. The method of claim 1, the populating the control UI element comprising:
populating the control UI element with one or more expanded control elements associated with a second continuous variable.

7. The method of claim 1, comprising:
responsive to receiving a neutral input associated with the current state indicator element, modifying the continuous variable based upon the neutral input.

8. The method of claim 2, comprising:
modifying the current state indicator element to visually reflect at least one of the modified first aspect or the modified second aspect.

9. The method of claim 3, comprising:
modifying the current state indicator element to visually reflect at least one of the modified first aspect or the modified second aspect.

10. The method of claim 1, the populating the control UI element comprising:
populating the control UI element with a radial expanded control element comprising the first expanded control element and the second expanded control element.

11. The method of claim 1, comprising:
responsive to identifying an interaction timeout associated with the current state indicator element, collapsing the control UI element.

12. The method of claim 11, the collapsing the control UI element comprising:
fading the first expand control element and the second expanded control element from the control UI element.

13. The method of claim 1, comprising:
modifying a visual aspect of at least one of the first expanded control element, the second expanded control element, or the current state indicator element based upon a current visual state of a user interface over which the control UI element is displayed.

14. The method of claim 1, comprising:
displaying the control UI element over a map user interface, the continuous variable corresponding to at least one of a view tilt variable or a view rotation variable for the map user interface.

15. A system for providing a control user interface (UI) element, comprising:
a control component configured to:
display a control UI element associated with a continuous variable;
populate the control UI element with a current state indictor element configured to display a current state of the continuous variable; and
responsive to receiving a show capabilities input associated with the current state indicator element, populate the control UI element with a first expanded control element associated with a first aspect of the continuous variable and a second expanded control element associated with a second aspect of the continuous variable.

16. The system of claim 15, the control component configured to at least one of:
responsive to receiving first analog input, through the current state indicator element, with respect to the first expanded control element, modify the first aspect according to the first analog input; or
responsive to receiving second analog input, through the current state indicator element, with respect to the second expanded control element, modify the second aspect according to the second analog input.

17. The system of claim 16, the control component configured to:
modify the current state indicator element to visually reflect at least one of the modified first aspect or the modified second aspect.

18. The system of claim 15, the control component configured to:
responsive to receiving a neutral input associated with the current state indicator element, modify the continuous variable based upon the neutral input.

19. The system of claim 15, the control component configured to at least one of:
responsive to receiving first discrete input, through the current state indicator element, with respect to the first expanded control element, modify the first aspect according to the first discrete input; or
responsive to receiving second discrete input, through the current state indicator element, with respect to the second expanded control element, modify the second aspect according to the second discrete input.

20. A computer readable medium comprising instructions which when executed at least in part via a processing unit perform a method for providing a control user interface (UI) element, comprising:
displaying a control UI element associated with a continuous variable;
populating the control UI element with a current state indictor element configured to display a current state of the continuous variable; and
responsive to receiving a show capabilities input associated with the current state indicator element, populating the control UI element with a first expanded control element associated with a first aspect of the continuous variable and a second expanded control element associated with a second aspect of the continuous variable.
